(19) United States
(12) Patent Application Publication
(10) Pub. No.: US 2007/0075894 A1
(43) Pub. Date: Apr. 5, 2007

(54) RF Pulse Shaping By Incremental Amplifier Turn On and Off

(75) Inventors: David H. Thibado, Baldwinsville, NY (US); Paul J. Romanowski, East Syracuse, NY (US)

Correspondence Address: BOND, SCHOENECK & KING, PLLC, ONE LINCOLN CENTER, SYRACUSE, NY, 13202-1355, US

(73) Assignee: LOCKHEED MARTIN CORPORATION, Bethesda, MD (US)

(21) Appl. No.: 11/163,072

(22) Filed: Oct. 4, 2005

(51) Int. Cl. G01S 7/282

(52) U.S. Cl. 342/204; 342/175

(57) ABSTRACT

The present invention is directed to a system for amplifying a radio frequency (RF) drive signal, the system includes a divider having one input port and N output ports. The divider is configured to split the RF drive signal into N-output signals, wherein N is an integer value. N-control elements are coupled to the divider. Each switch of the N-control elements is coupled to one of the N-output ports. N-amplifiers are coupled to the N-control elements. Each of the N-amplifiers is coupled to a corresponding one of the N-control elements, and each amplifier is turned ON in response to being driven by the corresponding one of the N-control elements. A combiner is coupled to the N-amplifiers and includes N-input ports and one output port. The N-inputs are coupled to the N-amplifiers. Each input of the N-inputs is configured to receive an RF signal propagating from a corresponding one of the N-amplifiers. The output port provides an RF output signal that is substantially equal to the sum of the RF signals propagating from the N-amplifiers.

### BACKGROUND OF THE INVENTION

1. Field of the Invention

The present invention relates generally to radio frequency (RF) systems, and particularly to shaping RF power amplification.

2. Technical Background

One method for generating high level RF and microwave signals is by combining multiple low power level signals to thereby generate a high power level signal. In an arrangement such as this, non-linear amplifiers, such as Class C amplifiers, are typically used to improve efficiency by minimizing the power dissipated when an output signal is not being generated. Further, Class C amplifiers only provide an output when they have a sufficient input drive signal. Class C amplifiers are typically ON at full power or OFF. The output signals are characterized by relatively fast rise and fall times; the rise and fall time may be less than 200 nanoseconds. The sharp rising and falling edges translate to undesirable high levels of energy in certain portions of the frequency spectrum.

FIG. 1 shows a frequency spectrum 1 for a current state of the art solid state amplifier along relative to National Telecommunications and Information administration (NTIA) specifications for congested air space and non-congested air space. In simple terms, the congested air space specification is the frequency spectrum enveloped required for radar emissions in the air spaces associated with populated areas that must accommodate a higher level of air traffic. For rural airports, emissions must follow the NTIA non-congested specification. Referring to FIG. 1, the relatively fast rise and fall time of certain solid state amplifiers generates high levels of spectrum content in frequency spectrum 1. In particular, spectrum 1 has a high spectral content that exceeds both the NTIA congested specification and the NTIA non-congested specification.

In one approach that has been considered, a waveguide filter is coupled to an output of the solid state amplifier. FIG. 2 shows a Butterworth Approximation of the waveguide filter. FIG. 3 shows the spectral response of the system. A system employing the waveguide filter clearly meets the NTIA spectrum requirements for both the non-congested specification and the congested specification. However, there are drawbacks with this approach. Referring to FIG. 2, the passband of the waveguide filter is centered at 2800 MHz. The amplitude response falls off rapidly as the frequency deviates from the filter's center frequency. Thus, the waveguide filter provides a fine solution for system that employs a single frequency. However, the waveguide filter cannot be used in a frequency agile radar system for obvious reasons. In another approach that has been considered, a voltage or current control system has been coupled to the amplifier to turn the amplifier ON and OFF at appropriate times. The frequency response may be adjusted somewhat by controlling the timing. However, this approach has drawbacks as well. The control system implementation is complex and, therefore, expensive.

What is needed is a system and method for shaping RF pulses in high output power systems that utilize non-linear solid state amplifiers.

### SUMMARY OF THE INVENTION

The present invention addresses the needs described above. The present invention is directed to high output power systems that may employ non-linear solid state amplifiers. The system of the present invention provides an economical means for shaping RF output pulses. In particular, the present invention adjusts the rise and fall times of the output pulse such that the spectral response meets applicable standards.

One aspect of the present invention is directed to a system for amplifying a radio frequency (RF) drive signal. The system includes a divider having one input port and N output ports. The divider is configured to split the RF drive signal into N-output signals, wherein N is an integer value. N-control elements are coupled to the divider. Each switch of the N-control elements is coupled to one of the N-output ports. N-amplifiers are coupled to the N-control elements. Each of the N-amplifiers is coupled to a corresponding one of the N-control elements, and each amplifier is turned ON in response to being driven by the corresponding one of the N-control elements. A combiner is coupled to the N-amplifiers and includes N-input ports and one output port. The N-inputs are coupled to the N-amplifiers. Each input of the N-inputs is configured to receive an RF signal propagating from a corresponding one of the N-amplifiers. The output port provides an RF output signal that is substantially equal to the sum of the RF signals propagating from the N-amplifiers.

In another aspect, the present is directed to a system for amplifying a radio frequency (RF) drive signal. The system includes a divider having one input port and N output ports. The divider is configured to split the RF drive signal into N-output signals, wherein N is an integer value. N-control elements are coupled to the divider. Each switch of the N-control elements is coupled to one of the N-output ports. N-amplifiers are coupled to the N-control elements. Each of the N-amplifiers is coupled to a corresponding one of the N-control elements, and each amplifier is turned ON in response to the corresponding one of the N-control elements being in a closed state. A combiner is coupled to the N-amplifiers and includes N-input ports and one output port. The N-inputs are coupled to the N-amplifiers. Each input of the N-inputs is configured to receive an RF signal propagating from a corresponding one of the N-amplifiers. The output port provides an RF output signal that is substantially equal to the sum of the RF signals propagating from the N-amplifiers. A control circuit is individually coupled to the N-control elements. The control circuit is configured to individually open and close each of the N-control elements in a predetermined sequence.

In another aspect, the present invention is directed to a radar system that includes a signal source configured to provide an input signal. A divider is configured to split the input signal into N-signals. A pulse shaping system is configured to amplify and selectively combine the N-signals in a predetermined sequence to form an RF output signal, whereby a rise time of the RF output signal is a function of the predetermined sequence.

In another aspect, the present invention is directed to a method for amplifying a radio frequency (RF) signal. The method includes the step of dividing the RF signal into N-output signals, wherein N is an integer value. The N-output signals are selectively conditioned such that the N-output signals are driven from a substantially attenuated state to a substantially non-attenuated state in a predetermined sequence. The conditioned N-output signals are then amplified. The conditioned and amplified N-output signals are combined to provide an RF output signal that is substantially equal to the sum of the conditioned and amplified N-output signals. The shape of the RF output signal is a function of the predetermined sequence.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a chart showing a frequency spectrum for a non-linear state of the art amplifier relative to the NTIA specifications;

FIG. 2 is a chart showing a Butterworth approximation for a system employing a waveguide filter;

FIG. 3 is a chart showing the spectral response for a system employing a waveguide filter;

FIG. 4 is a system diagram of a pulse shaping amplification system in accordance with an embodiment of the present invention;

FIG. 5 is a chart showing a modeled pulse rise time for a desired output;

FIG. 6 is a chart showing the spectral response for a system exhibiting the rise time shown in FIG. 5;

FIGS. 7A and 7B are timing charts for the switch assembly depicted in FIG. 6 in accordance with the present invention;

FIG. 8 is a chart showing a pulse rise time in accordance with another embodiment of the present invention;

FIG. 9 is a is a chart showing the spectral response for the system depicted in FIG. 6; and

FIG. 10 is a system diagram of a frequency agile radar system incorporating the pulse shaping amplification system shown in FIG. 6.

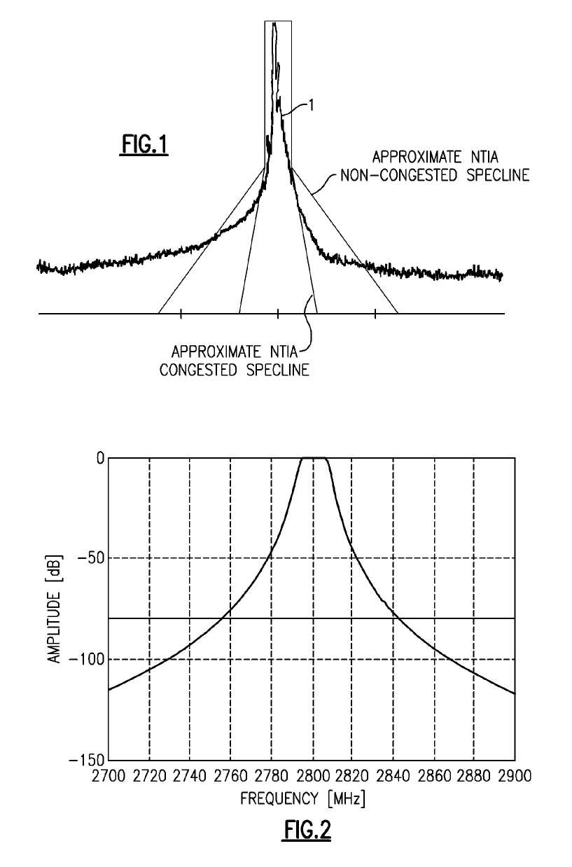

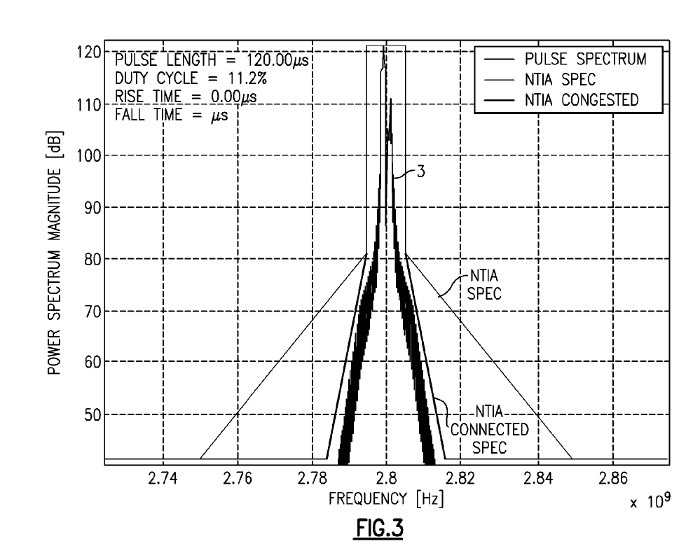

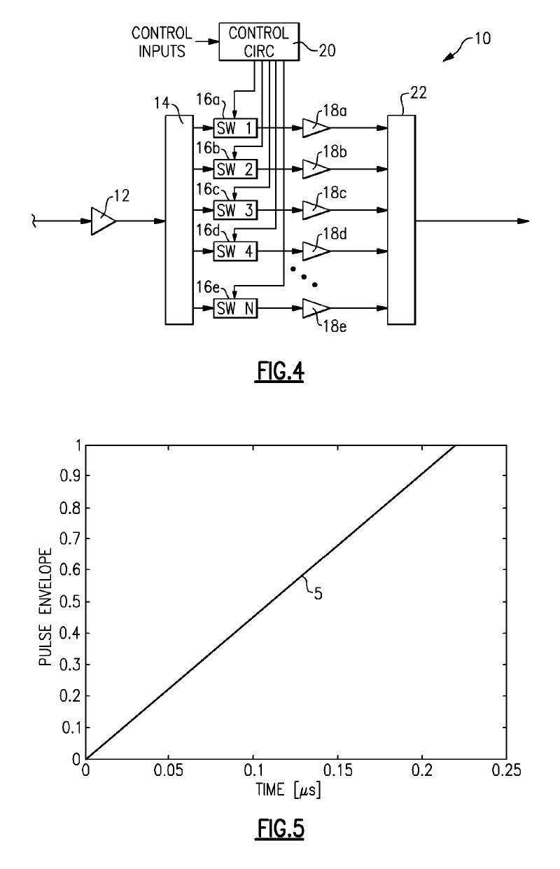

### DETAILED DESCRIPTION

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the pulse shaper of the present invention is shown in FIG. 4, and is designated generally throughout by reference numeral 10.

As embodied herein, and depicted in FIG. 4, a system diagram of a pulse shaping amplification system in accordance with an embodiment of the present invention is disclosed. System 1 0 includes a drive amplifier that is typically employed to turn a bank of cascaded amplifiers ON. As those skilled in the art will appreciate, the output of the amplifiers may be combined to create an output signal having a high power level, i.e., in the kilowatt range. In system 10, drive amplifier 12 is coupled to an RF power splitter 14. Power splitter 14 divides the drive signal into N-signals. Each of the N-signals having a power level that is, theoretically, 1/N the level of the drive signal. Of course, the signal will be smaller because of implementation losses. Accordingly, if N equals two, the theoretical power level is 3.0 dB lower than the input drive signal. If N equals 48, the theoretical level is 16.8 dB down from the input signal.

Each of the N-signals from divider 14 is connected to an RF control element 16. Each control element 16 is further connected to an amplifier 18, and individually controllable by control circuit 20. Control elements 16 may be of any suitable type depending on the drive signal provided to amplifiers 18. For example, in one embodiment, the control elements 16 are implemented using RF switches. In another embodiment, the control elements 16 are implemented using attenuators.

Amplifiers 18 are typically non-linear amplifiers. In one embodiment of the present invention the amplifiers are implemented using Class C amplifiers. The amplifiers 18 are connected to combiner 22. The combiner 22 combines the N-signals into a single amplified RF output signal. The output port of combiner 22 provides an RF output signal that is substantially equal to the sum of the RF signals propagating from the N-amplifiers. Of course, the actual output will be less because of the usual implementation losses that invariably are present in any system.

As shown in FIG. 4, control circuit 20 is individually coupled to each of the N-control elements 16. The control circuit is configured to individually drive each of the N-control element 16 in a predetermined sequence. The predetermined sequence determines the shape of the RF output pulse as well as the rise and fall time of the output pulse. In one embodiment of the present invention, the control circuit may be implemented as a digital sequence counter, a series of flip-flops and logic arranged to form a counter, or any other suitable arrangement. Control circuit 20 may be implemented using a field programmable gate array (FPGA) or by an application specific integrated chip (ASIC). Control circuit may also be coupled to a host processor (not shown). The host processor may vary sequence, and hence the shape of the output pulse, depending on a variety of circumstances, including conditions in the communications channel. As shown in FIG. 4, each of the N-amplifiers 18 are coupled to a corresponding one of the N-control elements 16. Each amplifier 18 is turned ON in response to the corresponding one of the N-control element 16 being in a closed state. Accordingly, the combination of divider 14, control elements 16, amplifiers 18, control circuit 20, and combiner 22 form a pulse shaping system that is configured to amplify and selectively combine the N-signals in a predetermined sequence to form an RF output signal having a shape and a rise time that is a function of the predetermined sequence.

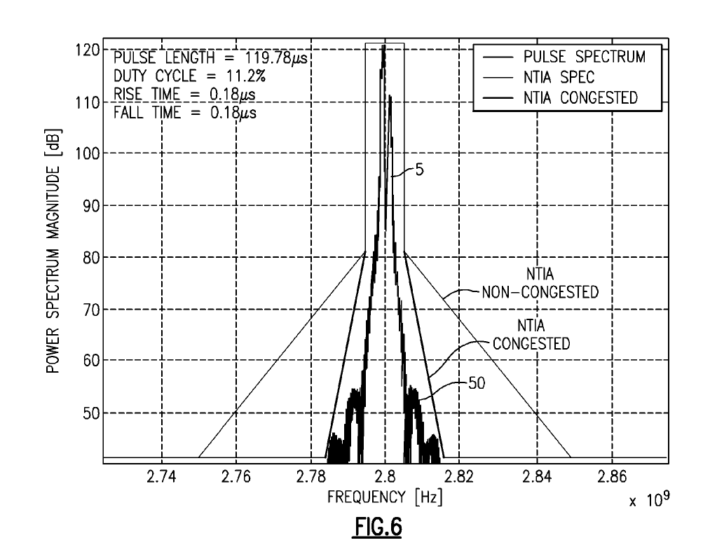

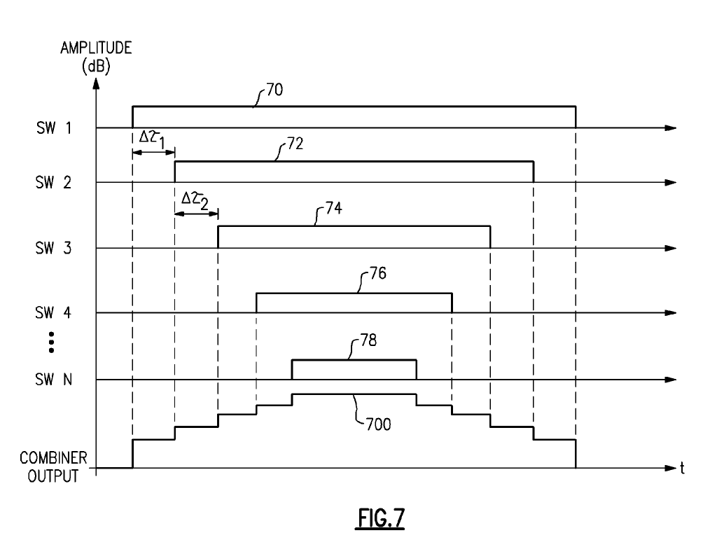

Referring to FIG. 5, a chart showing a modeled pulse rise time 5 for a desired output is shown. FIG. 6 is a chart showing the spectral response 6 for a system exhibiting the rise time shown in FIG. 5. In other words, the system designers select a pulse shape and the corresponding rise and fall time curves that generate the desired spectrum. Thus, the linear rise time shown in FIG. 5 produces a spectral output 6 having the side lobes 60 shown in FIG. 6. Note that side lobes 60 fit within the NTIA congested specification line.

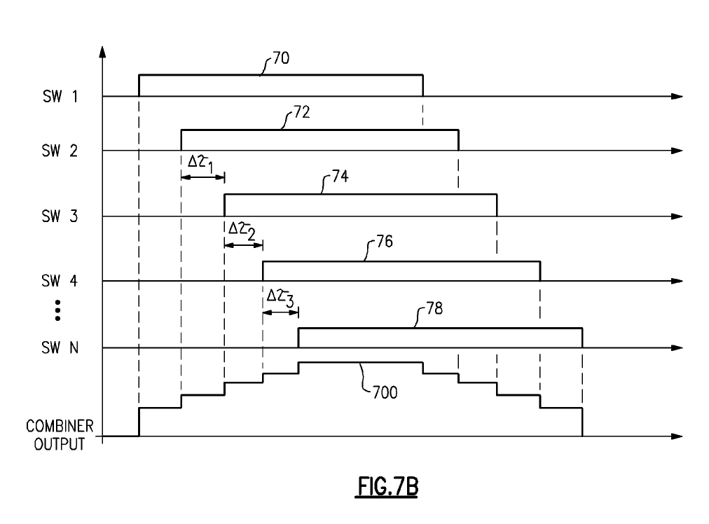

FIG. 7A and FIG. 7B are examples of timing charts for the switch assembly depicted in FIG. 4. Of course, FIGS. 7A and 7B are merely a diagrammatic depiction used to illustrate the principle of superposition employed by the present invention to generate an RF pulse having the desired characteristics. In FIG. 7A, when all of the control elements 16 are OFF, there is no output signal 700 propagating from combiner 22. When switch 1 is closed, amplifier 1 is turned ON and an output signal 700 is present. Subsequently, switch 2 is closed and amplifier 2 is turned ON. Combiner output 700 superimposes the output signals provided by amplifier 1 and amplifier 2. Ultimately, all of the amplifiers 18 are turned ON and output signal 700 reaches its peak value. FIG. 7B is an alternate method of generating the same combiner out put waveform. The pulse widths for each switch output (1 -N) are identical. Those of ordinary skill in the art will recognize that the time scale employed in FIG. 7A and FIG. 7B exaggerates the step-wise nature of the rise and fall time for clarity of illustration.

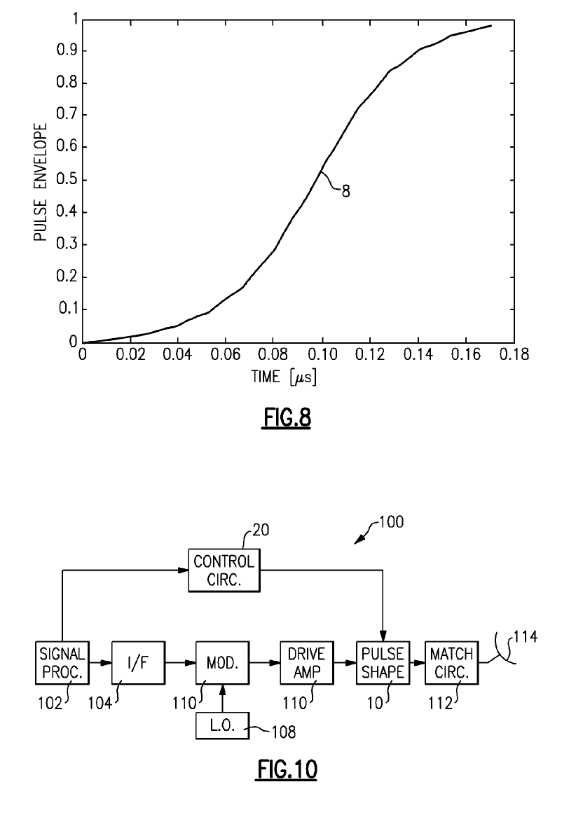

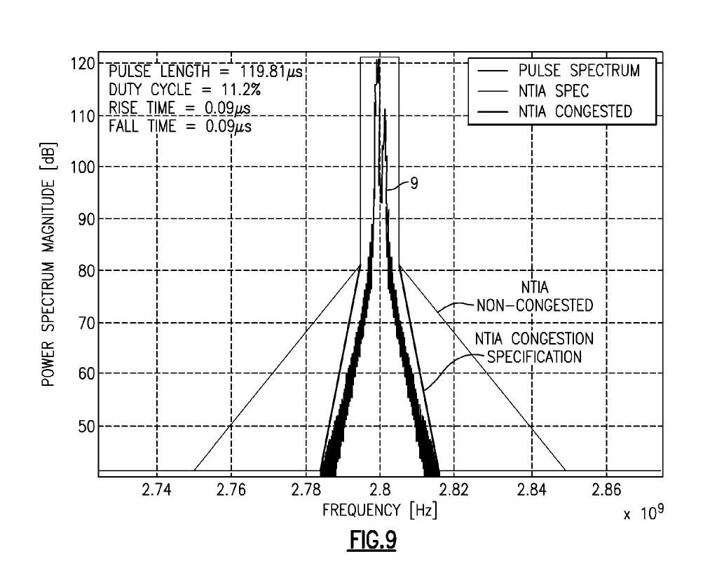

FIG. 8 is a chart showing a pulse rise time 8 implemented in another embodiment of the present invention. The predetermined switching sequence generated by control circuit 20 produces an RF pulse having an S-shaped rise time curve. FIG. 9 is a is a chart showing the spectral response 9 for the system depicted in FIG. 8. As shown in FIG. 9, the pulse length of the RF output signal is approximately 120 μsec. The rise time of the S-shaped curve depicted in FIG. 8 is only 0.09 μsec (i.e., 90 nanoseconds). Of course, those of ordinary skill in the art will appreciate that the rise time is often defined as the time it takes for the output pulse to rise from 10% of its final value to 90% of its final value.

It will be apparent to those of ordinary skill in the pertinent art that modifications and variations can be made to predetermined sequence implemented by control circuit 20 of the present invention depending on the specified output signal. For example, the examples provided herein are all directed to meeting the NTIA specification. However, the present invention should not be construed as being limited to this example. The present invention may be employed to generate an RF output signal having any predetermined shape and/or spectral characteristics.

FIG. 10 is a system diagram of a communications system 100 incorporating the pulse shaping amplification system shown in FIG. 4 and described herein. System 100 includes a baseband signal processor 102 configured to generate one or more output waveforms depending on the application. In one embodiment of the present invention, an intermediate frequency (IF) modulator is employed by the system 100 to modulate the baseband signal to an intermediate frequency. Subsequently, the IF signal is directed into modulator 106. Modulator 106 may be configured to multiply the IF signal by a signal provided by local oscillator 108. Those skilled in the art will recognize that system 100 may be a frequency agile radar system that varies frequency with respect to time.

The modulated signal is directed into drive amplifier 110. Drive amplifier 110 may be similar or identical to the drive amplifier depicted in FIG. 4. Drive amp 110 is coupled to the pulse shaping unit 10 of the present invention. The pulse shaping system, of course, is depicted in FIG. 4. System 100 typically includes an impedance matching network 112 disposed between system 10 and antenna 114. The matching network may include a number of reactive circuit elements arranged to provide optimum power transfer from system 10 and antenna system 114.

Those skilled in the art will recognize that a modern radar system typically includes additional systems and components not shown in FIG. 10. System 100 also includes volatile memory, such as a random access memory (RAM) or other dynamic storage devices. RAM is typically employed to store data and instructions for execution by the host processor or signal processor 102. System 100 may further include non-volatile memory such as read only memory (ROM), or other such static storage devices. ROM typically stores static information and instructions. System 100 may also include magnetic disks or optical disks, for persistently storing information and instructions.

The system may also include a display, such as a cathode ray tube (CRT), liquid crystal display, active matrix display, or plasma display, for displaying information to a user. An input device, such as a keyboard including alphanumeric and other keys, is also provided as part of the user interface. The user interface may also include a cursor control, such as a mouse, a trackball, or cursor direction keys, for communicating direction information and command selections to the processor and for controlling cursor movement on the display.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A system for amplifying a radio frequency (RF) drive signal, the system comprising:
a divider including one input port and N output ports, the divider being configured to split the RF drive signal into N-output signals, wherein N is an integer value;
N-control elements coupled to the divider, each switch of the N-control elements being coupled to one of the N-output ports;
N-amplifiers coupled to the N-control elements, each of the N-amplifiers being coupled to a corresponding one of the N-control elements, each amplifier being driven by the corresponding one of the N-control elements; and
a combiner including N-input ports and one output port, the N-inputs being coupled to the N-amplifiers, each input of the N-inputs being configured to receive an RF signal propagating from a corresponding one of the N-amplifiers, the output port providing an RF output signal that is substantially equal to the sum of the RF signals propagating from the N-amplifiers.

2. The system of claim 1, further comprising a control circuit individually coupled to the N-control elements, the control circuit being configured to individually drive each of the N-control elements in a predetermined sequence.

3. The system of claim 2, wherein the rise time of the RF output signal is a function of the predetermined sequence.

4. The system of claim 3, wherein the rise time of the RF output signal is a step-wise shape.

5. The system of claim 3, wherein the rise time of the RF output signal is an S-curve.

6. The system of claim 2, wherein the control circuit includes an ASIC.

7. The system of claim 2, wherein the control circuit includes an FPGA circuit.

8. The system of claim 1, wherein N is less than or equal to 24.

9. The system of claim 1, wherein N is less than or equal to 48.

10. The system of claim 1, wherein N is less than or equal to 96.

11. The system of claim 1, wherein the N-amplifiers include non-linear amplifiers.

12. The system of claim 11, wherein the N-amplifiers include Class C amplifiers.

13. The system of claim 1, wherein the N-control elements include attenuators.

14. The system of claim 1, wherein the N-control elements include RF switches.

15. A system for amplifying a radio frequency (RF) drive signal, the system comprising:
a divider including one input port and N output ports, the divider being configured to split the RF drive signal into N-output signals, wherein N is an integer value;
N-control elements coupled to the divider, each switch of the N-control elements being coupled to one of the N-output ports;
N-amplifiers coupled to the N-control elements, each of the N-amplifiers being coupled to a corresponding one of the N-control elements, each amplifier being driven by the corresponding one of the N-control elements;
a combiner including N-input ports and one output port, the N-inputs being coupled to the N-amplifiers, each input of the N-inputs being configured to receive an RF signal propagating from a corresponding one of the N-amplifiers, the output port providing an RF output signal that is substantially equal to the sum of the RF signals propagating from the N-amplifiers; and
a control circuit individually coupled to the N-control elements, the control circuit being configured to individually drive each of the N-control elements in a predetermined sequence.

16. A radar system comprising:
a signal source configured to provide an input signal;
a divider configured to split the input signal into N-signals; and
a pulse shaping system configured to amplify and selectively combine the N-signals in a predetermined sequence to form an RF output signal, whereby a rise time of the RF output signal is a function of the predetermined sequence.

17. The system of claim 16, further comprising an antenna coupled to the pulse shaping system, the antenna being configured to transmit the RF output signal.

18. The system of claim 16, wherein the pulse shaping system further comprises:
N-control elements coupled to the divider, each switch of the N-control elements being configured to receive one of the N-signals;
N-amplifiers coupled to the N-control elements, each of the N-amplifiers being coupled to a corresponding one of the N-control elements, each amplifier being turned ON in response to the corresponding one of the N-control elements being in a closed state; and
a combiner including N-input ports and one output port, the N-inputs being coupled to the N-amplifiers, each input of the N-inputs being configured to receive an RF signal propagating from a corresponding one of the N-amplifiers, the output port providing an RF output signal that is substantially equal to the sum of the RF signals propagating from the N-amplifiers.

19. The system of claim 18, further comprising a control circuit individually coupled to the N-control elements, the control circuit being configured to individually drive each of the N-control elements in a predetermined sequence.

20. The system of claim 19, wherein the rise time of the RF output signal is a function of the predetermined sequence.

21. The system of claim 20, wherein the rise time of the RF output signal is a step-wise shape.

22. The system of claim 20, wherein the rise time of the RF output signal is an S-curve.

23. The system of claim 16, wherein N is less than or equal to 24.

24. The system of claim 16, wherein N is less than or equal to 48.

25. The system of claim 16, wherein N is less than or equal to 96.

26. The system of claim 16, wherein the N-amplifiers include non-linear amplifiers.

27. The system of claim 26, wherein the N-amplifiers include Class C amplifiers.

28. The system of claim 16, wherein the signal source further comprises:
a signal processor configured to provide a baseband output signal;
at least one modulator configured to convert the baseband output signal into the RF output signal.

29. The system of claim 16, wherein the N-control elements include attenuators.

30. The system of claim 16, wherein the N-control elements include RF switches.

31. A method for amplifying a radio frequency (RF) signal, the method comprising:
dividing the RF signal into N-output signals, wherein N is an integer value;
selectively conditioning the N-output signals, the N-output signals being driven from a substantially attenuated state to a substantially non-attenuated state in a predetermined sequence;
amplifying the conditioned N-output signals; and
combining the conditioned and amplified N-output signals to provide an RF output signal that is substantially equal to the sum of the conditioned and amplified N-output signals, a shape of the RF output signal being a function of the predetermined sequence.

32. The method of claim 31, wherein the shape of the RF output signal is a function of a rise time of the RF output signal.

33. The method of claim 32, wherein the rise time of the RF output signal is a step-wise shape.

34. The method of claim 32, wherein the rise time of the RF output signal is an S-curve.

35. The method of claim 31, wherein the step of amplifying is performed by N-non-linear amplifiers.

36. The method of claim 35, wherein the non-linear amplifiers are Class C amplifiers.

37. The method of claim 31, wherein the step of selectively conditioning the N-output signals is performed by N-control elements.
